(19) United States
(12) Patent Application Publication
(10) Pub. No.: US 2024/0408541 A1
(43) Pub. Date: Dec. 12, 2024

(54) POLLUTANT REMOVAL APPARATUS AND METHOD

(71) Applicant: Daphne Technology SA, Saint-Sulpice (CH)

(72) Inventors: William Jamieson Ramsay, Saint-Sulpice (CH); Juan Mario Michan, Saint-Sulpice (CH); Steven Iglesiias, Saint-Sulpice (CH)

(73) Assignee: Daphne Technology SA, Saint-Sulpice (CH)

(21) Appl. No.: 18/702,392

(22) PCT Filed: Oct. 13, 2022
(86) PCT No.: PCT/EP2022/078459

§ 371 Date: Apr. 18, 2024

(30) Foreign Application Priority Data
Oct. 19, 2021 (GB) 2114915.8
Apr. 8, 2022 (GB) 2205191.6

(51) Int. Cl. B01D 53/50; B01D 53/14; B01D 53/18; B01D 53/34; B01D 53/58; B01D 53/76; B01D 53/92; B01D 53/96

(52) U.S. Cl. CPC B01D 53/50; B01D 53/1431; B01D 53/1493; B01D 53/18; B01D 53/346; B01D 53/58; B01D 53/76; B01D 53/92; B01D 53/96; B01D 2252/103; B01D 2257/302; B01D 2257/406; B01D 2258/01; B01D 2259/10; B01D 2259/122

(57) ABSTRACT

There is provided an apparatus and for removing pollutants from a gas. The apparatus comprises a gas flow path along which gas passes from an inlet to an outlet in use; and a cooling device on the gas flow path and orientated so as to direct the gas flow path upward towards the outlet. The apparatus is arranged in use to provide water and gaseous reagent to gas upstream of the cooling device in quantities based on one or more properties of the gas and a cooling capability of the cooling device so as to cause the reagent to react with one or more constituents of the gas to produce a reaction product and to cause the gas to reach its saturation point when passing through the cooling device thereby causing water in the gas to capture the reaction product, condense and pass out of the gas.

### FIELD OF THE INVENTION

The present disclosure relates to removal of pollutants from a gas through a chemical reaction and separation, such as removal of sulphur oxides (SOx), or ammonia (NH3, NH₃), from a gas, the gas being intended to be an exhaust gas, for example, from an industrial engine, such as those, running on fuels that contains sulphur and/or ammonia.

### BACKGROUND

Exhaust emissions from industrial engines powered by fuels with sulphur content, i.e. fuels containing sulphur, mainly comprise nitrogen, oxygen, carbon dioxide (CO2, CO₂) and water vapour, plus smaller quantities of nitrogen oxides (NOx), sulphur oxides (SOx), carbon monoxide (CO), various hydrocarbons at different states of combustion and complex particulate matter (PM). Sulphur oxides are produced during combustion of fossil fuels that contain sulphur, whereby the amount of SOx in fuel exhausts vary according to natural differences in the sulphur content of fuels.

The dominant constituent, making up more than 95% of the SOx emission from combustion of fossil fuels, is sulphur dioxide (SO2, SO₂). SO₂ is a toxic gas, directly harmful for both fauna and flora, and when present in the atmosphere leads to acid rain.

Industrial engines may alternatively be powered by fuels containing ammonia (NH3, NH₃), i.e. fuels containing ammonia. Exhaust emissions from engines powered by fuels containing ammonia mainly comprise nitrogen, oxygen, carbon dioxide (CO2, CO₂) and water vapour, plus smaller quantities of ammonia (NH₃, NH3), nitrogen oxides (NOx) and nitrous oxide (N₂O, N2O). The ammonia in these emissions is unburnt ammonia released in the exhaust gas, known as ammonia slip. These emissions are produced during combustion of fuels containing ammonia, and can negatively impact human and animal health while also damaging ecosystems.

Fuels containing ammonia can comprise over 95% ammonia, or may comprise ammonia in combination with other fuels referred to as pilot fuels. Pilot fuels may be diesel or other fuels containing sulphur. Accordingly, fuel used to power an industrial engine may contain both sulphur and ammonia. The ratio of sulphur to ammonia in such fuels can vary according to requirements. The exhaust emissions from fuels containing both sulphur and ammonia are a combination of the exhaust emissions for fuels containing sulphur and the exhaust emissions for fuels containing ammonia, listed above.

Industrial engines are commonly used in the shipping industry and represent an important fraction of the propulsion of the global fleet. These industrial engines are adapted to use on board ships and are called marine engines. In response to harmful impacts of pollutants the International Maritime Organization (IMO), through its Marine Environment Protection Committee (MEPC), introduced regulations for the prevention of air pollution under Annex VI of the International Convention for the Prevention of Pollution from Ships (MARPOL) Convention. This imposes a framework of mandatory limits on emissions of SOx and NOx.

To meet reduced SOx emission limits, ships can operate on low-sulphur residual and distillate fuels, and in the longer term, alternatives such as LNG (liquefied natural gas), biofuels, DME (dimethyl ether), methanol, and fuels containing ammonia may provide solutions. However, there is limited availability of natural low-sulphur fuels and the refinery process for desulphurisation is costly and energy demanding.

If using fuels containing sulphur, alternatives to these options are Exhaust Gas Treatment Systems (EGTS) known as SOx scrubbers, which clean the exhaust gas to reduce SOx emissions to a level that is equivalent to the required fuel sulphur content. This offers the flexibility to either operate on low-sulphur fuels or to use higher sulphur fuels in combination with a SOx scrubber.

If using fuels containing ammonia, there are currently no scrubbers for marine use to remove NH3 and therefore there are no Exhaust Gas Treatment Systems available for ammonia-fueled engines that can be used to clean the exhaust gas to reduce NH3 pollutants.

Currently there are two main types of SOx scrubber. These are wet scrubbers, which use water (using either seawater or fresh) as the scrubbing medium; and dry scrubbers, which use a dry chemical as a scrubbing medium. Wet scrubbers are further divided into open loop systems (that use seawater) and closed loop systems (that use fresh water with the addition of an alkaline chemical). Hybrid systems, which can operate in both open loop and closed loop modes, also exist. For wet scrubbers, the term “scrubbing” is typically intended to mean “absorbing”, meaning that SO₂ is absorbed by the aqueous solution.

When using a wet open loop SOx scrubber, the net result is formation of sulphate ions in the water and gaseous carbon dioxide, which is released to the atmosphere. The amount of the carbonate (CO₃—) and bicarbonate (HCO₃—) ions as well as other minor anions to react with hydrogen cations determine the so-called alkalinity or buffering capacity, which in turn is a measure of the amount of SO₂, which can be absorbed in the water. The main disadvantage is that the discharge water is extremely damaging and toxic to aquatic life. Open loop wet SOx scrubbers have therefore been banned in a number of countries and regions.

To address this issue, closed loop SOx scrubbers could be used. However, these also discharge small quantities of treated washwater (i.e. water passed through a scrubber and used in the scrubbing process) to reduce the concentration of sodium sulphate. If uncontrolled, the formation of sodium sulphate crystals will lead to progressive degradation of the washwater system. Furthermore, residue removed from SOx scrubber washwater is a waste product that must, when used on a ship, be stored on board, landed ashore and disposed of appropriately.

It can be advantageous to use a dry scrubber to overcome the challenges of wet scrubbing. Dry SOx scrubbers typically use calcium hydroxide however, which is classified as harmful to eyes and skin, and the inhalation of dust should be avoided. An alternative is to use calcium carbonate, more commonly referred to as limestone. Due to the need for particle filters, storage and handling of the powdered limestone reactant and gypsum product, usual scrubbing with limestone is considered inappropriate on ships though. A further alternative is to use potassium or sodium bicarbonate salts. The cost of materials for these typically limits the application of this alternative to small installations. Another major disadvantage for usage on a ship is that, depending on the conditions, a large amount of freshwater will be required, to which access is usually limited on a ship.

Both wet scrubbing and dry scrubbing methods described above, rely on heterogeneous reaction conditions where chemical reactions occur between reaction materials in different phases. This typically limits the reaction rate due to reactant molecules becoming saturated during reactions, which stalls further progress of a reaction. This typically makes such methods unusable in marine applications.

Homogeneous reactions (i.e., reactions where the reaction materials are in the same state) can be used to overcome this limitation. Sometimes, homogenous reactions can be catalysed with water, provided the reaction materials are soluble in water. Due to water being needed to catalyse such reactions, there is often uncontrollable condensing of water causing excess water content. In applications where there is limited storage capacity, such as in marine or mobile applications, this counteracts any advantages homogeneous reactions could provide, however.

For marine applications, another challenge is the changing conditions when a ship sails through different waters. Once a scrubber system has been installed on a ship, only limited degrees of freedom are left for adjusting the operation of the scrubber to comply with the changing ambient conditions. Examples of such possible conditions are high engine load, high sulphur content, lower water alkalinity (which is relevant to open loop wet scrubbers), the ship being in emission controlled areas and/or extremely low water temperature.

There is therefore a need for an adaptable scrubbing mechanism with limited, yet easily storable and transportable, by-products that are safe to handle with the mechanism also being capable of functioning effectively when receiving gas at flow rates producible by an engine.

### SUMMARY OF INVENTION

According to a first aspect, there is provided an apparatus for (i.e. suitable for) removing pollutants from a gas, the apparatus comprising: (a conduit, for example, defining) a gas flow path along which gas passes from an inlet to an outlet in use; and a cooling device on the gas flow path and orientated so as to direct the gas flow path upward towards the outlet, wherein the apparatus is arranged in use to provide water and gaseous reagent to gas (passing from the inlet to the outlet and) upstream of the cooling device in (known) quantities based on one or more properties of the gas and a cooling capability of the cooling device so as to cause the reagent to react with one or more constituents of the gas to produce a reaction product and to cause the gas to reach its saturation point when passing through the cooling device thereby causing water in the gas to capture (such as by dissolving) the reaction product, condense and pass out of the gas (such as by becoming too heavy to remain entrained within the gas, falling and/or adhering to a surface).

An apparatus according to the first aspect is able to provide a wet scrubber (in some examples, the apparatus according to the first aspect is a wet scrubber). However, instead of having a rate-limited heterogeneous reaction the apparatus is able to provide a homogenous reaction thereby not limited in rate. Even with the application of a homogenous reaction though, using the apparatus according to the first aspect has no requirement for washwater, meaning no washwater is expelled. This therefore allows removal of pollutants from a gas while producing minimal by-product that remains in liquid form thereby having the ability for removal by passage through a pipe or some other easy form of transport.

As such, while having a final by-product that is solid would be more space and resource efficient, maintaining the by-product in liquid form allows for easier transportation and storage. This would not be an issue in a large industrial complex, such as, for example, a metal production plant, but on, for example, a container ship, oil tanker or cruise ship, where the number of crew available is minimal and space is too limited to allow vehicles to operate, sacrificing some storage volume for ease of transport provides a benefit.

Further, it is known that by increasing water content of a gas, the efficiency of removing at least some pollutants increases. Conversely, the higher the gas temperature the lower the efficiency of removing those pollutants is. In an ideal system, these factors would be optimised. However, to produce minimal liquid by-product and to be able to accept gases from a hot source, such as an engine, make it simpler for any system to provide limited water content to a gas, and to limit cooling of the gas. To reduce pollutant content in a gas while achieving the by-product being maintained in liquid form and at a minimum quantity, the apparatus according to the first aspect allows a balance to be achieved. This is due to cooling being provided, but also identifying input variables to allow water and reagent quantities provided to be tailored so a desired or predetermined outcome complimenting the primary and secondary aims can be achieved.

The cooling device may be arranged in use to cool gas passing through it. This may be achieved by use of a mechanical refrigerator, which may include or be an alternative to cooling that may be achieved by use of a cooling medium, such as a coolant, absorbing heat from the gas in use.

The reagent may be provided to the gas by any suitable means. Typically, the apparatus further comprises a reagent feed upstream of the cooling device, the apparatus being arranged in use to provide reagent to the gas by the reagent feed being arranged in use to pass reagent into the gas. While the reagent could be provided in a reservoir in the apparatus, using a feed allows there to be no reservoir of reagent in the apparatus limiting the volume of the apparatus and providing an ability to store the reagent elsewhere. Typically, the reagent feed may be an injector, sprayer, nozzle, spray nozzle or some other device or suitable means for passing gas or liquid (in liquid or aerosolised form) into the gas flow path. Whichever form the reagent feed takes, it may be connected to a pipe or other form of conduit.

The reagent may be any reagent capable of reacting with one or more constituents of a gas. Preferably, the one or more constituents of the gas are pollutants and the quantity of reagent provided to the gas is based on the concentration of the pollutants in the gas. This allows a suitable amount of reagent to be provided to the gas to react with the pollutants, which means the reagent is used efficiently and a balance can be achieved between the quantity being provided and storage capacity for the source of reagent. Of course, other measures of pollutant quantity in the gas may be used.

Typically, the reagent reacts with the pollutants to produce the reaction product. Therefore when water in the gas captures the reaction product, condenses, and passes out of the gas, the pollutants are effectively removed from the gas. While the reagent could be in a form other than a gas, the reagent being gaseous allows a homogeneous reaction with pollutant in the gas, thereby not limiting the reaction rate by requiring a site on a reaction component for a reaction to take place.

If the fuel being used to produce the gas is known, it is possible to determine the one or more types of pollutant that are typically present in the exhaust emissions and to derive approximate amounts, and types, of pollutant that the gas will contain. This therefore allows a calculation of the quantities, and types, of reagent to be provided to the gas to be made based on fuel producing gas. Typically, the apparatus may further comprise a pollutant monitor arranged in use to detect pollutants in the gas downstream of the cooling device. This active measuring of the quantity of pollutant in the gas, such as the pollutant concentration, allows the amount of pollutant present in the gas to be known more accurately, avoiding reagent being wasted or insufficient reagent being provided. A similar effect may be achieved if the pollutant monitor is arranged in use to detect pollutants in the gas upstream of the cooling device.

Typically, the amount of reagent provided to the gas may be adjusted based on the pollutant concentration detected in the gas by the pollutant monitor.

Typically, the type of reagent provided to the gas may be adjusted based on the pollutant type detected in the gas by the by the pollutant monitor. Optionally, when the pollutant comprises NH3 and SOx, the type of reagent provided to the gas may be adjusted based on the ratio of NH3 to SOx in the gas.

Typically, the pollutant monitor is upstream of the location on the gas flow path where the reagent is provided. Advantageously, by positioning the pollutant monitor upstream, the reaction can be controlled more easily because pollutant can be monitored before the reagent is added to ensure a suitable amount and type of reagent is added.

Typically, the pollutant monitor is arranged in use to identify concentration of pollutant.

Typically, for engines powered by fuels containing sulphur, the reagent may comprise gaseous ammonia (NH₃, NH3) and the pollutants may be sulphur oxides (SOx). Preferably, for engines powered by fuels containing sulphur, the reagent is gaseous ammonia. The ammonia is typically arranged in use to react with the pollutants in the gas.

When the reagent is ammonia, the source of ammonia provided to the gas may be anhydrous ammonia gas, aqueous ammonia (also known as liquid ammonia or ammonia water; typically the concentration of ammonia in such a reagent is between 25% and 28% by weight), or generated from decomposition of urea (provided, for example, from a urea to ammonia system capable of producing ammonia from urea solution).

Typically, for engines powered by fuels containing ammonia, the reagent may comprise gaseous sulphur oxides (SOx) and the pollutant may be ammonia (NH₃, NH3). Preferably, for engines powered by fuels containing ammonia, the reagent is gaseous SOx. SOx may include SO2 and/or SO3. For example, the reagent could include sulphur dioxide (SO2, SO₂), sulphur trioxide (SO3, SO₃), or a mix of SO2 and SO3. The sulphur oxides are typically arranged in use to react with the ammonia in the gas.

When the reagent is sulphur oxides, the source of sulphur oxides provided to the gas may be anhydrous sulphur oxides, sulphur dioxide solution (also known as sulphurous acid; typically the concentration of sulphur dioxide in such a reagent is between 7% and 13% by weight), or generated from the combustion of sulphur or of combusting materials that contain sulphur, such as elemental sulphur. Burning elemental sulphur as the source of SOx provides SOx in a concentration of approximately 100% by weight, which is advantageous because such a high concentration limits the volume of reagent needed.

Typically, for engines powered by fuels containing both ammonia and sulphur, the reagent may comprise gaseous ammonia (NH3, NH₃) and/or gaseous sulphur oxides (SOx), and the pollutants may include both SOx and NH3. Preferably, for engines powered by fuels containing both ammonia and sulphur, the reagent (as provided to the gas flow path) is SOx and NH3. When the reagent is both SOx and NH3, the SOx and NH3 are preferably provided to the gas flow path using separate inlets. Optionally, for engines powered by fuels containing both ammonia and sulphur, the reagent is either SOx or NH3. The required reagent typically depends on the ratio of ammonia and sulphur in the fuel. Preferably, the source of the SOx reagent provides between 90% and 100% by weight of SOx (which typically means the source of the SOx reagent is anhydrous SOx, such as that provided in a bottle, or to from burning elemental sulphur), and the source of the NH3 reagent provides between 25% and 100% by weight (wt %) of NH3. The range of 25-100 wt % is meant to include anhydrous ammonia (100% ammonia in a bottle) and aqueous ammonia (25-28% in a bottle) as options. It is advantageous to use anhydrous ammonia because this would take less volume. Anhydrous ammonia it is harder to safely handle on board however. It is advantageous to use aqueous ammonia as it is easier to safely handle on board, but this would take require higher volumes to be used. As such, the different concentration requirements are, overall, due to the available reagent sources and the stoichiometry of the reaction between the pollutant and the reagent.

In the apparatus, the water may be provided to the gas by any suitable means. Typically, the apparatus further comprises a water feed upstream of the cooling device, the apparatus being arranged in use to provide water to the gas by the water feed being arranged in use to pass water into the gas. While the water could be provided in a reservoir in the apparatus, using a feed allows there to be no reservoir of water in the apparatus limiting the volume of the apparatus and providing an ability to store the water elsewhere or draw the water from elsewhere. Typically, the water feed may be an injector, sprayer, nozzle, spray nozzle or some other device or suitable means for passing gas or liquid (in liquid or aerosolised form) into the gas flow path. Whichever form the water feed takes, it may be connected to a pipe or other form of conduit.

The water feed may be arranged in use to provide water in the form of water vapour.

As noted above, the provision of water to the gas is partially based on the cooling capability of the cooling device, the exhaust temperature, and the flow. By this it is intended to mean the amount of cooling or reduction in temperature able to be provided by the cooling device. There are many ways this can be calculated or identified. Typically, the quantity of water provided to the gas may be based on a temperature in (a part of) the cooling device and (optionally) the temperature of the gas upstream of the water feed. This allows the temperature to which the gas will decrease (i.e. a cooling capability of the cooling device) to be calculable, thereby allowing the saturation point to be identified so as to allow the amount of water being provided to be limited.

Typically, the apparatus may further comprise a temperature sensor positioned upstream of the water feed. This temperature sensor may be arranged in use to measure the temperature of the gas. This may be in addition to, or as an alternative to one or more other temperature sensors located at or downstream of the water feed, which is/are used to monitor temperature of the gas along the flow path.

Typically, the apparatus may further comprise a temperature sensor positioned in the cooling device, such as at a downstream end of the cooling device. This temperature sensor may be arranged in use to measure the temperature of the cooling device.

The use of one or more temperature sensors allows accurate information to be used when calculating the saturation point from which the amount of water to provide to the gas is then able to be calculated and may be incorporated in control systems, such as proactive or dynamic control systems

The condensed solution of water that passes out of the gas may simply be allowed to drain out of the apparatus or be transported elsewhere. However, typically, the apparatus further comprises a collector positioned to catch condensed solution of water and captured reaction product passing out of the cooling device. This provides a means of capturing the condensed solution instead of it passing out of the system or simple not considering the condensed solution. As such, the captured condensed solution may be put to use and/or potential contamination or harm it could cause outside of the apparatus is limited.

The collector and cooling device may be positioned relative to each other so as to allow the condensed solution to drain into the collector from the cooling device in use when the water passes out of the gas. This avoids a pipe run being needed between the cooling device and collector.

The apparatus may be arranged in use to provide condensed solution from the collector to the gas (i.e. into the gas flow path) upstream of the cooling device as at least a portion of the water to be provided to the gas. This increases the water content of the gas allowing the amount of water provided separately to this to be reduced or eliminated and/or allowing the concentration of the condensed solution to be decreased.

Typically, the apparatus may further comprise a (first) condensed solution feed arranged in use to pass condensed solution out of the collector into the gas passing along the flow path to the cooling device. This feed may be in the form of an injector, sprayer or nozzle, spray nozzle or some other device or suitable means for passing gas or liquid (in liquid or aerosolised form) into the gas flow path. Whichever form the first condensed solution feed takes, it may be connected to the collector.

Additionally or alternatively to the condensed solution being provided to the gas upstream of the cooling device, the apparatus may be arranged in use to provide condensed solution from the collector into the gas flow path (i.e. to the gas) downstream of the cooling device. This allows the concentration of collected condensed solution to be increased, since this causes more reaction product to be captured in the condensed solution. Additionally, this can wash the cooling device, reducing fouling of the device. This may be achieved by the condensed solution being provided to the cooling device.

Additionally or alternatively, the gas flow path may pass to a (i.e. the) surface of the condensed solution caught at the collector (i.e. gas may pass to a surface of the condensed solution caught at/by the collector), the heat from the gas passing along the gas flow path thereby passing to the condensed solution. The heat from the gas is passed to the condensed solution due to the solution receiving heat directly from the gas stream. As a consequence, the condensate (i.e. the condensed solution) will partially evaporate, increasing the humidity content of the gas stream producing a recirculation effect. This is due to the water evaporating from the condensate condensing again in the collector, increasing the pollutant removal. Additionally, this will raise the concentration of solution since water, which dilutes the solution, is removed by this process.

Typically, the apparatus may further comprise a (second) condensed solution feed arranged in use to pass condensed solution out of the collector into the gas flow path downstream of the cooling device. This feed may be in the form of an injector, sprayer, or nozzle, spray nozzle or some other device or suitable means for passing gas or liquid (in liquid or aerosolised form) into the gas flow path. Whichever form the second condensed solution feed takes, it may be connected to the collector. For example, any one or more of the feeds could be a liquid stream supply, but typically may be a spray, such as a spray nozzle.

The second condensed solution feed may be provided to a downstream end of the cooling device.

The first and second condensed solution feed may draw condensed solution from the collector from a common (i.e. single) output of the collector or from separate outputs from the collector. When there is a common output, there may be (only) a single pump arranged in use to pass condensed solution along the first and/or second feed. There may be multiple pumps of course and/or there may be a value arranged in use to direct condensed solution along the first feed and/or second feed. When there are multiple (i.e. separate) outputs from the collector, such as one output per feed, there may be one (such as only one) or more pumps per feed.

The apparatus may be arranged in use to monitor the concentration of reaction product in the condensed solution in the collector, the apparatus being further arranged in use, based on the monitored concentration, to adjust water content of the gas at the cooling device. This provides a feedback loop (such as to a control systems) allowing the concentration of the reaction product in the condensed solution to be tailored and adjusted to be a desired level, thereby giving improved control over said concentration.

When the concentration (of reaction product in the condensed solution in the collector) is monitored, the apparatus may be arranged in use to decrease the concentration by providing condensed solution from the collector (and/or water) to the gas upstream of the cooling device. This may be achieved as set out above. This increases the water content of the gas and thereby reducing the concentration of the reaction product in the condensed solution without needing to provide more water in addition to water already provided to the apparatus, thus optimising water usage

Alternatively, or additionally, when the concentration (of reaction product in the condensed solution in the collector) is monitored, the apparatus may be arranged in use to increase the concentration by providing condensed solution from the collector into the gas flow path downstream of the cooling device. This may be achieved as set out above. This allows increased reaction product concentration without needing more reagent or additional gas to provide components with which to react the reagent since the condensed solution captures further reaction product as it, for example, passes through the cooling device.

The concentration of reaction product in the captured condensed solution may be maintained between about 30% weight and about 60% weight. This maintains the solution in liquid form without the reaction product precipitating out of solution in a range of environmental conditions to which the apparatus may be exposed while also limiting the volume of condensed solution needing storing. We have found an optimal concentration (depending on local environmental conditions) of the reaction product concentration may be about 41% weight of the condensed solution. In other situations, the concentration of reaction product in the captured condensed solution may be maintained within a wider range, such as between about 10% weight and about 90% weight. Such concentrations may be achieved using the same reaction mechanism or an alternate reaction mechanism to produce the reaction products.

The cooling device may be any form of device capable of providing cooling, such as a heat pump, refrigerator, cooling tower or adiabatic cooler. Typically, the cooling device may be a heat exchanger. This allows simple cooling of the gas, and, in combination with passing gas upward towards the outlet (for example due to an upright orientation), causes condensation that forms on the walls of the heat exchanger to continually wash the heat exchanger surfaces, cleaning those surfaces thereby reducing fouling.

The heat exchanger may be a mixing heat exchanger, such as when the cooling device is a direct cooling device. Typically, however, the cooling device may be an indirect cooling device, which, when a heat exchanger is used, means the heat exchanger may be an unmixed heat exchanger. This avoids or at least limits liquid or gas from the heat exchanger passing into the gas or condensed solution thereby limiting the volume of condensed solution.

Typically, the heat exchanger may be a shell and tube heat exchanger. Additionally, the tubes may be orientated in an upright orientation.

Typically, a cooling medium of the heat exchanger may enter the heat exchanger at a downstream end of the heat exchanger. This keeps the heat exchanger coolest at the downstream end so as to have the lowest temperature gas saturation point as far along the gas flow path as possible.

Typically, the cooling medium of the heat exchanger may exit the heat exchanger at an upstream end of the heat exchanger. This counter-flow allows for efficient cooling of gas passing through the heat exchanger and enables gas to rise through the heat exchanger around the whole of each tube and minimises fouling and clogging due to the condensation washing all parts of each tube approximately equally. Additionally, having this orientation provides a more consistent temperature across the length of the heat exchanger parallel to the gas flow path.

By “upright” we intend to mean vertical or at a slight deviation (such as up to 5 degrees, °, of deviation) from vertical, and therefore (generally) perpendicular to the earth's surface or parallel to the direction in which gravity acts. Of course, when the apparatus is provided on a moveable vehicle, such as a ship, the upright orientation may shift to follow the movement of the vehicle instead of remaining completely vertical. This limits fouling since condensation forms on the surfaces of the tubes, at the downstream end as a minimum, and washes the tube surfaces.

The cooling device may be arranged in use to cool the gas to between about 2 degrees centigrade (° C.) and about 70° C., such as between 50° C. and 60° C., and typically to 56° C. This provides a balance between cooling provided, which is more difficult to achieve the lower the temperature to which cooling is being provided, and reaction rate and capability, which reduces as temperature increases. For example, for emissions from fuels containing sulphur, wherein the emissions contain SOx as a pollutant, around 100% of SOx is able to be removed from gas using the apparatus of the first aspect when the temperature of the cooling device is between about 2° C. and about 35° C., with, in a contrasting manner, little to no reaction occurring at temperatures of about 70° C.

Similarly, for emissions from fuels containing ammonia, wherein the emissions contain NH3 as a pollutant, around 100% of NH3 is able to be removed from gas using the apparatus of the first aspect when the temperature of the cooling device is between about 2° C. and about 35° C., with, in a contrasting manner, little to no reaction occurring at temperatures of about 70° C. This may be the temperature to which the gas is cooled by the cooling device instead of the temperature of the cooling device, which, for example, the temperature in the heat exchanger be maintained at least 2° C. and preferably more than 5° C. below the dew point of the gas.

Further, for emissions from fuels containing both sulphur and ammonia, wherein the emissions contain the pollutants SOx and NH3, around 100% of the SOx and the NH3 is able to be removed from the gas using the apparatus of the first aspect at the above temperatures.

Due to water provided to the gas, water content in the gas may vary between 5% by volume and 15% by volume, such as about 10% by volume. The water content of the gas, also referred to as the humidity, is proportional to the efficiency with which pollutant(s) are removed from the gas. As such, this range of water content balances the amount of water used, reaction rate, and concentration of condensed solution. If, on one hand, the water content is too high, the condensed solution becomes too dilute and requires additional storage capacity. On the other hand, if the water content is too low, then the chances of the reaction product precipitating out of solution increase. Additionally, if the lower limit of the range were lowered further, water may need to be removed from a typical combustion engine exhaust.

According to a second aspect, there is provided a method of removing pollutants from a gas, the method comprising: providing water and gaseous reagent to a gas; and passing the gas through a cooling device to cool the gas, wherein the water and reagent are provided to the gas (upstream of the cooling device) in (known) quantities based on one or more properties of the gas and a cooling capability of the cooling device so as to cause the reagent to react with one or more constituents of the gas to produce a reaction product and to cause the gas to reach its saturation point when passing through the cooling device thereby causing water in the gas to capture the reaction product, condense, and pass out of the gas.

While the gas may come from any suitable or relevant source, the gas is typically a waste gas or exhaust gas, such as from a motor or engine.

The method may further comprise monitoring one or more properties of the gas before providing water and reagent, and, based on one or more monitored properties, adjusting the quantity of water and/or reagent provided to the gas. This may be incorporated into control systems of an apparatus and may enable optimal usage of the apparatus or system with which the method is applied.

The method may further comprise collecting condensed solution of water and reaction product and monitoring the concentration of reaction product in the condensed solution; and adjusting, based on the monitored concentration, the concentration by providing condensed solution (and/or water, such as from an alternative source) to the gas upstream of the cooling device or providing condensed solution to a downstream end of the cooling device.

According to a third aspect, there is provided a wet scrubber comprising: a conduit defining a gas flow path along which gas passes from an inlet to an outlet in use; and a cooling device within the conduit through which the gas flow path passes and orientated so as to direct the gas flow path upward towards the outlet, wherein the scrubber is arranged in use to provide water and gaseous reagent to gas passing upstream of the cooling device in (known) quantities based on one or more properties of the gas and a cooling capability of the cooling device so as to cause the reagent to react with one or more constituents of the gas to produce a reaction product and to cause the gas to reach its saturation point when passing through the cooling device thereby causing water in the gas to capture the reaction product, condense and pass out of the gas.

### BRIEF DESCRIPTION OF FIGURES

Example apparatus and example methods are described in detail below with reference to the accompanying figures, in which:

FIG. 1 shows a block diagram of an example apparatus;

FIG. 2A shows a schematic of an example apparatus;

FIG. 2B shows a schematic of an example apparatus; and

FIG. 3 shows a flow diagram of an example method.

### DETAILED DESCRIPTION

We have developed an apparatus for removing pollutant from a gas and a corresponding process. It is intended the gas is waste or exhaust gas, such as from an engine or motor. In one example, the pollutant being removed is SOx. In another example, the pollutant being removed is NH3. In a further example, the pollutant being removed is SOx and NH3. There are of course examples, where the gas is from one or more other sources, and, with or without adaptation of the process and/or apparatus, other pollutants may be removable from the gas in addition to or separately from removal of SOx and/or NH3.

The apparatus that has been developed is a form of wet scrubber. In wet scrubbers, the primary removal and collection mechanism is achieved by collision of liquid droplets with the tiny, suspended, gas and solid particles and their subsequent capture and incorporation within the liquid droplet. This inherently implies that the exhaust gas temperature, normally greater than 230 degrees centigrade (° C.) for diesel engines, be reduced to allow for the scrubbing medium to maintain liquid phase, such as, in a condensing mode, by lowering the temperature below the dew point of the scrubbing liquid.

The flow of scrubbing liquid (seawater or freshwater with alkaline additive) in known wet scrubbers must be sufficient to reduce the exhaust gas temperature below dew point. This is in addition to providing the minimum alkalinity to remove SO₂.

The flow of scrubbing liquid (freshwater with acidic additive) in land-based wet scrubbing processes to remove NH₃ must be sufficient to reduce the exhaust gas temperature below dew point. This is in addition to providing the minimum acidity to remove NH₃.

It is accepted that wet gas scrubbers will obtain high efficiencies when the particle radius, particle density, and relative velocity between particle and target droplet are high and when gas viscosity and target droplet size are low. For practical engineering purposes, efficiency of a wet scrubber is a function of the total power dissipated in turbulence in the system regardless of geometry of the particular device used. The apparatus and process according to an aspect disclosed herein does not have the same limit on efficiency.

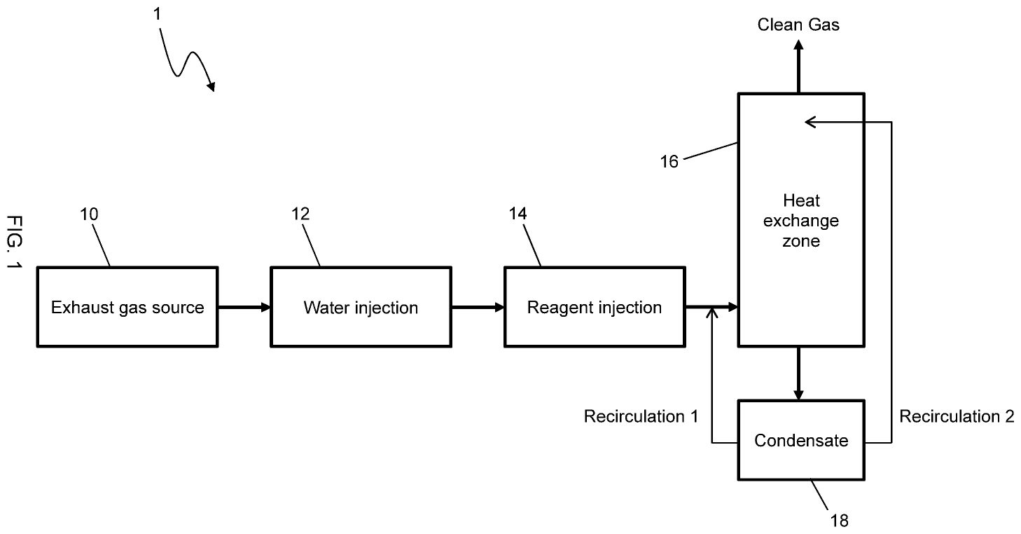

A block diagram of an example process and corresponding general arrangement for an apparatus to achieve this is generally illustrated at 1 in FIG. 1. In this process a gas stream is received from an exhaust gas source 10. Water injection 12 and reagent injection 14 into the gas stream is then carried out. In one example, the pollutant being removed is SOx and the reagent is NH3. In another example, the pollutant being removed is NH3 and the reagent is SOx. In a further example, the pollutant being removed is SOx and NH3 and the reagent is NH3 and/or SOx. In an example providing both NH3 and SOx as reagents, the reagents may comprise two reagent streams.

In some examples the water injection 12 is water, and in other examples, steam or vapour is provided as the water injection. The reagent injection 14 is provided in gaseous form in the example shown in FIG. 1. It is possible for the water and reagent injections to be carried out with the water injection provided before, after or at the same time as the reagent injection based on the relative position of the water and reagent injections upstream/downstream of each other.

Following the water injection 12 and reagent injection 14 into the gas stream received from the exhaust gas source 10, the gas stream has a greater humidity, in the range of about 5% to about 15% by volume. Additionally, the gas stream can be expected to have cooled from a temperature greater than 200° C. to a temperature of greater than 70° C.

The gas stream is then passed into a heat exchange zone 16. Through an arrangement set out in more detail below, this passes the gas stream upward through the heat exchange zone, the gas stream is cooled by actively cooling the gas to its saturation point. In the example shown in FIG. 1, this is achieved by an indirect contact cooling device.

Due to the conditions provided from water injection, reagent injection, and the heat exchange zone, reactions occur between the reagent, pollutants in the gas stream and water to ultimately form ammonium sulphate. Ammonia is an alkaline gas at standard temperature and pressure (defined as a temperature of 273.15 K (0° C., 32° F.) and an absolute pressure of exactly 105 Pa (100 kPa, 1 bar)). Sulphur dioxide is an acidic gas at standard temperature and pressure. When gaseous NH₃, SO₂ and water vapour are mixed, white crystalline materials are formed. In some examples the following chemical reactions occur:

2NH_{3(g)}+SO_{2(g)}+H₂O_{(g)}→(NH₄)₂SO₃₍ₛ₎

NH_{3(g)}+SO_{2(g)}+H₂O_{(g)}→NH₄HSO₃₍ₛ₎

In one example, the ammonia is injected as a reagent and the SO₂ is a pollutant in the exhaust gas. In another example, the ammonia is a pollutant in the exhaust gas and the SO₂ is injected as a reagent. In another example, SOx and NH3 are pollutants in the exhaust gas and NH3 and/or SOx are injected as the reagent. In each of these examples, ammonium sulphate is formed.

When the fuels contains both sulphur and ammonia, the NH3 and SOx in the exhaust emissions may react to form ammonium sulphate. However, the ratio of NH3 and SOx in the exhaust emissions may not match the stoichiometry of the reaction. Therefore, it is typically necessary to provide additional NH3 and/or SOx as a reagent to remove the remaining pollutant from the exhaust gas. In various examples, the oxidation of sulphites to sulphates occurs after product particle dissolution. This occurs, for example, when the particles accumulate a water film from vapour condensation or are dissolved in water. (NH₄)₂SO₃ and NH₄HSO₃ are understood to easily be oxidised to form ammonium sulphate, (NH₄)₂SO₄. Therefore, the following reaction schemes occur in some examples in liquid water phase:

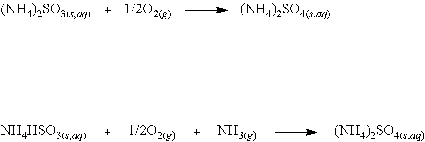

The reaction is also able to proceed in a liquid phase via dissolved gases (denoted “g,aq”):

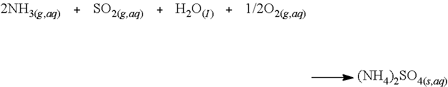

The reaction of NH₃, SO₂, and water to form ammonium sulphate is known to be highly dependent on the gas temperature and humidity, whereby the SO₂ removal efficiency (%) drops to less than 50% at water content (% by volume) of less than 5% and at temperatures greater than 55° C. It is known that the presence of water vapour is not only needed to drive the reaction further, but may act as a catalyst in forming the product.

We have found the reaction yields particles of diameters in the range from about 1.2 microns (μm) and about 2.0 μm with a mean of about 1.5 μm. In relation to this, by “particles” we mean water droplets containing dissolved ammonium sulphate, denoted as (NH₄)₂SO_{4(s,aq)}.

The cooling of the gas causes condensates to form. Under suitable conditions, this condensation falls out of the gas stream. Details are set out below as to how this is typically achieved according to an aspect disclosed herein, but in some examples, this could instead be achieved by instigating turbulence or some other form of agitation of the gas stream. This would cause the condensing water droplets to collide with each other, increasing in size until their mass is too high for the droplets to remain suspended by the gas, causing the water droplets to fall out of the gas.

According to an example, particulate matter contained in the gas stream is trapped (via dissolution) and removed from the gas stream by the condensing water vapour. This cleans the gas stream of a substantial portion of its contained particulate matter. The cleaned gas is then able to pass out of the heat exchange zone 16. The particulate matter however, being saturated in water vapour, is removed from the heat exchange zone 16 and is passed from the system in a condensate stream. The condensate stream (i.e. solution of condensed water and particulate matter, also referred to as a condensed solution) loaded with the removed particulate matter drains from the heat exchange zone under the influence of gravity. This is collected in a chamber 18.

As a means of reducing the amount of water from outside the process/apparatus the process needs to receive by water injection 12, a means to enhance cleaning in the heat exchange zone 16 and manage concentration of the reaction product, ammonium sulphate, the chamber 18 has two recirculation loops. In FIG. 1, these are denoted “Recirculation 1” and “Recirculation 2”. Recirculation 1 passes condensate from the chamber into the gas stream upstream of the heat exchange zone. Recirculation 2 passes condensate from the chamber into a downstream end of the heat exchange zone. How this achieved and the reasons to do this are set out in more detail below.

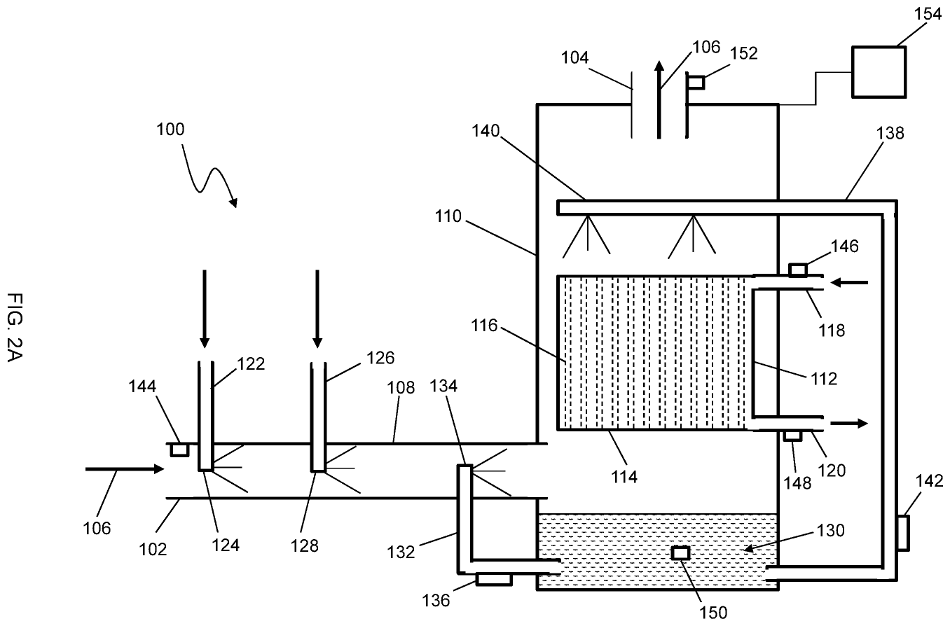

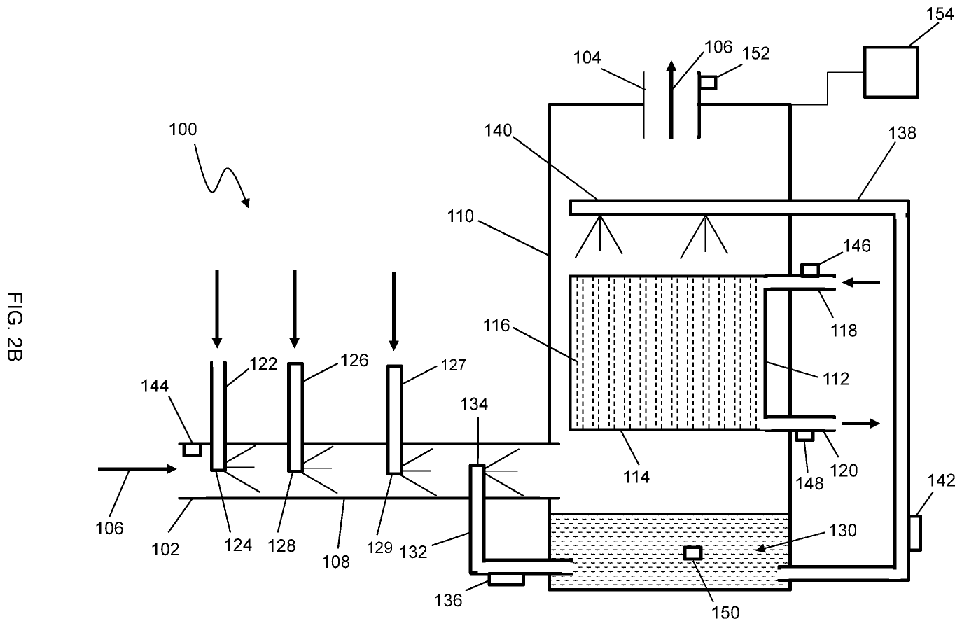

The process set out, in relation to FIG. 1, is able to be implemented using the example apparatus generally illustrated at 100 in FIG. 2A and FIG. 2B. This provides a conduit defining a gas flow path between an inlet 102 and an outlet 104 through which a gas stream 106 is able to pass. The example apparatus shown in FIG. 2A is suitable for removing either NH3 or SOx pollutants, produced by engines powered by fuels containing either ammonia or sulphur respectively, by providing a single reagent stream for conveying either SOx or NH3, respectively. The example apparatus shown in FIG. 2B is suitable for removing both NH3 and SOx pollutants, produced by engines powered by fuels containing both ammonia and sulphur, by providing two reagent streams for conveying SOx and NH3. For the sake of simplicity, the example apparatus shown in FIG. 2B comprises the same features as those shown in FIG. 2A, however the apparatus in FIG. 2B comprises an additional reagent feed as described below.

For ease of reference the terms “upstream” and “downstream” are used to state relative positions and directions of travel. The term “upstream” is intended to mean closer to the inlet 102 or in the direction towards the inlet away from the outlet 104. The term “downstream” is intended to mean the opposite of this, so closer to the outlet or in the direction towards the outlet away from the inlet.

The conduit is, in the examples shown in FIG. 2A and FIG. 2B, formed of two sections, a pipe 108 and a collector 110. In these examples, the pipe is horizontal (i.e. is perpendicular to the direction in which gravity acts or, taking account for movement or rocking of a ship, is intended to act relative to other aspects of the ship). While in other examples the pipe may have a different orientation, maintaining a horizontal orientation limits any liquid flowing back towards the source of the gas. Since in the examples shown in FIG. 2A and FIG. 2B this is intended to be an engine, this avoids liquid passing into an engine via its exhaust outlet, where it would cause damage. Should the pipe have a different orientation, it would of course be possible to devise a means of avoiding liquid passing back to the engine.

One end of the pipe 108 forms the inlet 102. An opposing end of the pipe connects to the collector 110. The collector is a vessel with the outlet 104 located, in the examples shown in FIG. 2A and FIG. 2B, at its top. In other examples, the outlet is able to be in other positions. Regardless of the position of the outlet however, it is intended there is a difference in altitude between the connection of the pipe and the outlet, with the outlet having the higher altitude. In use, this causes gas passing from the inlet to the outlet via the pipe and container passes upward when exiting the pipe and travelling towards the outlet.

In these examples, the collector 110 has a chamber portion at its base. In FIG. 2A and FIG. 2B, the pipe 108 is shown to connect to the collector in a side of the collector above (i.e. at a higher altitude in the collector than) the chamber portion. In other examples, the chamber portion may be provided by a separate container connected to the collector. Additionally or alternatively, the relative arrangement of the pipe connection to the collector and chamber portion may be different in other examples.

The collector 110 has a heat exchanger 112 located across the gas flow path. This is located between the connection of the pipe 108 to the collector and the outlet 104. The heat exchanger depicted in FIG. 2A and FIG. 2B has a shell 114 within which is disposed a plurality of heat exchange tubes 116. The tubes are relatively large diameter, smooth walled and upright, such as vertical.

The heat exchanger 112 is manufactured using known materials, such as stainless steel, and using known processes. This is achieved without specific tailoring or special adaptation to the apparatus or process according to an aspect disclosed herein being provided.

In the heat exchanger 112, the tubes 116 are spaced apart to provide fluid channels between adjacent tubes. This allows a cooling medium to circulate and to cool the tubes. In this example, the cooling medium is a liquid, and typically water, but in other examples is a gas. In order to provide cooling, in the examples shown in FIG. 2A and FIG. 2B, a cooling water stream is introduced into the heat exchanger inlet 118 and exits via the heat exchange outlet 120. In these examples, the heat exchanger inlet is downstream of the heat exchange outlet within the collector 110. This provides a counter flow to the flow of gas through the heat exchanger. In other examples the heat exchange inlet is upstream of the heat exchange outlet within the collector or some other suitable arrangement.

Returning to the pipe 108, this has a first feed 122 able to inject material into the pipe in use due to having a first inflow 124 at an end located within the pipe. The first feed is connected to a reservoir (not shown) or other source from which the material is drawn to be provided to the pipe. The first inflow is typically a nozzle, spray nozzle, injector or some other device or suitable means for passing gas or liquid (in liquid or aerosolised form) to be provided to the gas stream 106, such as by being inserted or injected into the pipe.

A second feed 126 is also connected to the pipe. Like the first feed, the second feed is able to inject material into the pipe in use due to having a second inflow 128 at an end located within the pipe. The second feed is also connected to a reservoir (not shown) or other source from which the material to be provided to the pipe is drawn. As with the first inflow 124, the second inflow is typically a nozzle, spray nozzle, injector or some other device or suitable means for passing gas or liquid (in liquid or aerosolised form) to be provided to the gas stream 106, such as by being inserted or injected into the pipe.

While in FIG. 2A and FIG. 2B, the first feed 122 is shown as being located upstream of the second feed 126, the first and second feeds may be located at the same point along the gas flow path. In use, one of the first feed or second feed in FIG. 2A provides water either in liquid, steam or vapour form, and the other provides gaseous reagent. For an exhaust gas comprising SOx, the reagent is ammonia. For an exhaust gas comprising ammonia, the reagent is SOx.

As set out in more detail below, the chamber portion collects condensate 130 in use. A third feed 132 is connected between the chamber portion and the pipe 108 and is arranged in use to provide condensate to the pipe by injection. The injection is achieved by the third feed having a third inflow 134 at an end located within the pipe. In various examples, the condensate is drawn out of the chamber and injected into the pipe by a pump 136 connected to the third feed. In a similar manner to with other inflows, the third inflow is typically a nozzle, spray nozzle, injector or some other device or suitable means for passing gas or liquid (in liquid or aerosolised form) to be provided to the gas stream 106, such as by being inserted or injected into the pipe.

In FIG. 2B, an additional feed is connected to the pipe relative to the apparatus shown in FIG. 2A: a fifth feed 127. Similarly to the first and second feeds 122, 126 shown in FIG. 2A, the fifth feed 127 is also connected to the pipe and the fifth feed 127 is able to inject material into the pipe in use due to having a fifth inflow 129 at an end located within the pipe. The fifth inflow 129, similarly to the previously described inflows, is typically a nozzle, spray nozzle, injector or some other device or suitable means for passing gas or liquid (in liquid or aerosolised form) to be provided to the gas stream 106, such as by being inserted or injected into the pipe. In FIG. 2B the second feed 126 is connected to a first reservoir (not shown) and the fifth feed 127 is connected to a second reservoir (not shown).

The first and second reservoirs comprise first and second sources respectively, from which the material to be provided to the pipes are drawn. The first and second reservoirs are separate. In this example, NH3 is stored in the first reservoir and SOx is stored in the second reservoir (or a source of SOx is providable in place of a second reservoir). The example apparatus shown in FIG. 2B is therefore suitable for removing both SOx and NH3 pollutants from exhaust emissions using the second and fifth feeds to provide NH3 and SOx reagent respectively, as required. Alternatively the reagents held in the reservoir may be swapped. In FIG. 2B, the fifth feed 127 is positioned between the second feed 126 and the third feed 132. In other examples, the fifth feed may be positioned at any location along the pipe relative to the other feeds, and may be positioned at the same location as another feed.

As with the first feed 122 and second feed 126, while the examples of FIG. 2A and FIG. 2B show the third feed 132 located downstream of the first and second feeds (and also downstream of the fifth feed in FIG. 2B), these feeds may be arranged in any order in other examples. This can include two or more of the feeds being located at the same position along the gas flow path as each other. In the examples shown in FIG. 2A and FIG. 2B, the third feed provides recirculation 1 set out above in relation to FIG. 1.

Recirculation 2 set out in relation to FIG. 1 is provided in the example apparatus 100 of FIG. 2A and FIG. 2B by a fourth feed 138. This provides a liquid connection between the chamber portion and a position downstream of the heat exchanger 112 in the collector 110. In use, the fourth feed is arranged to provide condensate 130 to the collector by injection. This is achieved by the fourth feed having a fourth inflow 140 located, in the examples shown in FIG. 2A and FIG. 2B, downstream of the heat exchanger and orientated to pass condensate into the downstream end of the heat exchanger. Other orientations are provided in other examples, and in some examples, the fourth inflow is provided at the downstream end of the heat exchanger. The condensate is passed along the fourth feed from the chamber portion to the fourth inflow by a pump 142 connected to the fourth feed. As with other inflows, the fourth inflow is typically a nozzle, spray nozzle, injector or some other device or suitable means for passing gas or liquid (in liquid or aerosolised form) to be provided to the gas stream 106, such as by being inserted or injected into the pipe.

While the examples shown in FIG. 2A and FIG. 2B include recirculation 1 and recirculation 2 as independent feeds in the form of the third feed 132 and fourth feed 138, in other examples, there is a single outlet from the collector 110. This would be instead of the third feed and fourth feed. Such a joint feed could have a single outlet from the collector and would then provide condensate 130 to one or both of the outlets from recirculation 1 and recirculation 2 at the third inflow 134 and fourth inflow 140 respectively. This is able to be achieved using a single pump that passes condensate along separate branches to the two different injection lines. This would potentially have a valve for directing flow, or a conduit system that branches into the two different injection lines, each with a pump. Implementing such an arrangement may reduce the level of control over the amount of condensate provided through recirculation 1 and recirculation 2, but may have other advantages.

The apparatus 100 shown in FIG. 2A and FIG. 2B has a plurality of sensors arranged in use to each monitor one or more properties of gas, liquid or gas/liquid component that is passing through, being generated or being used within the apparatus. Five example sensors are shown in FIG. 2A and FIG. 2B. These are a first sensor 144, a second sensor 146, a third sensor 148, a fourth sensor 150 and a fifth sensor 152. In other examples, there may be more sensors arranged to monitor the same and/or different properties to one or more other sensors, and in various examples there may be less sensors with the sensors present each monitoring one or more properties.

In the examples shown in FIG. 2A and FIG. 2B, the first sensor 144 is arranged in use to monitor the mass flow of the gas, and in some examples also monitors water content and pollutant content of the gas and/or temperature of the gas. This sensor is shown in FIG. 2A and FIG. 2B as being located at the inlet 102. In other examples, the first sensor is located elsewhere, or is replaced by a data feed provided from the source of the gas 106, such as one or more engines providing the same information.

The second sensor 146 is arranged in use to monitor a cooling capability of the heat exchanger 112, such as by monitoring a temperature of a cold intake, such as the heat exchanger inlet 118. As such, in the examples shown in FIG. 2A and FIG. 2B, the second sensor is located at the heat exchanger inlet. In other examples, the second sensor is located elsewhere, is replaced by a data feed provided from the source of the cooling medium, such as one or more reservoirs or water intakes providing the same information, or is absent and data from another source is used to monitor temperature of the gas as it leaves the heat exchanger or collector 110.

The third sensor 148 is arranged in use to monitor the heat transferred in the heat exchanger 112, such as by monitoring a temperature of coolant at a hot outtake, such as the heat exchanger outlet 120. As such, in the examples shown in FIG. 2A and FIG. 2B, the third sensor is located at heat exchanger outlet. In other examples the third sensor is located elsewhere, for example, in the tubes of the heat exchanger, or is replaced by a data feed provided from the source where coolant further goes. The temperature identified by the third sensor is able to be compared to a temperature identified by the second sensor 146 or an assumed coolant input temperature in order to identify the heat transferred and thereby the temperature of the gas output form the heat exchanger. In other examples, the third sensor is located elsewhere, is replaced by a data feed provided from the location to which the cooling medium is output, such as one or more reservoirs or water outlets providing the same information, or is absent with data from another source being used to monitor temperature of the gas as it leaves the heat exchanger or collector 110.

The fourth sensor 150 is arranged in use to monitor a concentration of ammonium sulphate in the condensate 130. As such, in the examples shown in FIG. 2A and FIG. 2B, the fourth sensor is located in the chamber portion of the collector 110. In FIG. 2A and FIG. 2B, the fourth sensor is shown located at a mid-point of the condensate. While the mid-point may move based on quantity of condensate present in the chamber portion, an approximate position of the mid-point is able to be estimated. In some examples the fourth sensor is held in this position by a support (not shown). In various examples, the fourth sensor floats at this point, which may be achieved by tailoring the buoyancy of the sensor. In other examples, the fourth sensor is located elsewhere, is replaced by a data feed provided from an alternative source, or is absent.

The fourth sensor 150 is a density sensor in the examples shown in FIG. 2A and FIG. 2B. In some examples, the sensor is some other sensor capable of monitoring the concentration of ammonium sulphate in the condensate 130.

The fifth sensor 152 is arranged in use to measure various properties of the gas stream 106, such as (but not limited to) SO₂ and NH₃ concentration in the exhaust, and/or concentration of other gases in the exhaust, and/or temperature of the exhaust. As such, to provide this ability, in the examples shown in FIG. 2A and FIG. 2B, the fifth sensor is located to at the outlet 104. In other examples, the fifth sensor, or another sensor, such as the first sensor 144, is able to be located elsewhere to monitor one or more properties of the gas stream, as long as one or more properties of the gas stream are able to be measured.

In various examples, the first sensor 144 and the fifth sensor 152 are the same sensor and are located in the same position (i.e. they are a single sensor instead of two sensors as shown in FIG. 2A and FIG. 2B). This of course means that if there is a first sensor or a fifth sensor then, respectively, the fifth sensor or the first sensor may not be present. Both sensors are able to be present however, and this would increase the data collection capability, which can be advantageous.

Each sensor of the apparatus 110 and each feed is (electrically) connected to a controller 154 in use. The controller is able to receive signal from each sensor and adjust the material provided by each feed to optimise the concentration of ammonium sulphate in the condensate. This is typically achieved by measuring the mass flow of exhaust (i.e. constituents of the gas other than air) in the gas 106, potentially the water content of the gas, cooling capability of the heat exchanger 112, and concentration of ammonium sulphate in the condensate and adjusting the amount of water, reagent and/or condensate provided in the pipe 108 and/or adjusting the amount of condensate provided by the fourth feed 138. The sensors monitor in a conventional manner to identify the relevant property or property state or condition(s).

In various examples, the controller 154 is able to manage the functioning and/or make adjustments to the apparatus 100 without receiving input from one or more of the sensors, or for one or more sensors not to be present. As long as one or more properties of the gas, such as a quantity of pollutant by weight, volume, concentration or some other measure, and a cooling capability of the cooling device, such as by determining the how much the heat exchanger 112 is able to cool the gas 106, how much heat the heat exchange is able to extract from the gas, or the temperature of the gas leaving the apparatus 100 compared to an assumed, expected, measured or known (for example due to being a sensor output of a separate system, such as the engine, with which the apparatus may be able to integrate or receive data from) temperature of the gas entering the apparatus, are able to be identified, the controller will be able to conduct sufficient operation of the apparatus, such as by adjusting input quantities from each feed present, to achieve a suitable effect. In a typical example, this is achieved by using at least the fifth sensor 152 located, as shown in FIG. 2A and FIG. 2B, at an outlet 104 to the collector 110, with that sensor being arranged to monitor, at least, temperature of the gas passing through the outlet and pollutant content or concentration in the gas. As indicated above, this sensor may also have other capabilities.

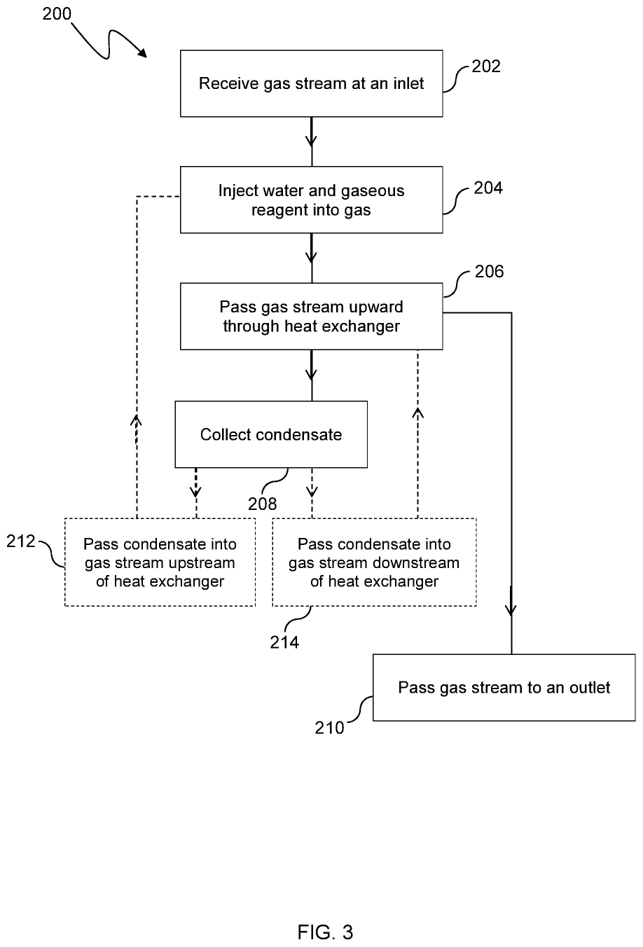

Overall, this forms part of (and, in some examples, manages) the process generally illustrated at 200 in FIG. 3. As such, in various examples, a process according to an aspect disclosed herein operates using the apparatus 100 as described above in relation to FIG. 2A or FIG. 2B, and so is typically carried out by the process illustrated in FIG. 3 being applied.

Initially, a gas stream 106 is received at a gas inlet 102 at step 202. In examples where this is an exhaust gas stream from an industrial engine, they are typically at an absolute pressure of a little above atmospheric, such as 105 kPa, with fluctuations within a range of, for example, approximately 87 kPa to 140 kPa. Conditions of between about 80 kPa to about 150 kPa could be experienced, however. When using fuels containing sulphur, the gas can be expected to be at a temperature of about 230° C. When using fuels containing ammonia, the gas can be expected to be at a temperature between about 190° C. to about 500° C. When using fuels containing both sulphur and ammonia, the gas can be expected to be at a temperature between about 190° C. to about 500° C. . . .

The gas stream 106 is passed along the gas flow path and water and gaseous reagent are injected into the gas at step 204. This is achieved using first feed 122 and second feed 126.

Following injection of water and reagent, the gas stream is passed upward through a heat exchanger 112. A substantial contribution to the efficiency of a process according to an aspect disclosed herein occurs by the increase in mass of each individual particle in a gas. It is intended that by the term “particle” we mean either solid particle produced from the reaction between SO₂ and NH₃ or liquid particle that has dissolved reaction species by condensation of water on its surface as the humidified gas stream is cooled. This phenomenon is, of course, well known. Particles or particulate means with mass increased by water condensation can be considered a trapping but not a collection mechanism. Instead, in some examples, the primary collection mechanisms at work in this process is thermophoresis or Stefan flow.

Thermophoresis is a collection effect induced by removal of heat from the gas stream 106. Due to the heat exchange surfaces (such as heat exchange tubes 116) being at a lower temperature than that of the gas passing through the heat exchanger 112, a corresponding temperature gradient is developed between particles carried in the gas stream and the heat exchange surfaces. This temperature differential causes fine particles to be driven toward the colder heat exchange surface by differential molecular bombardment arising from the temperature gradient. In contrast with known wet scrubbers, wet gas scrubbers relay upon inertial impaction and interception of solid (and/or gaseous) particles by liquid droplets. Prior to the process according to an aspect described herein, this effect has been recognized as the most important collection mechanism in the usual particle scrubber.

In some examples, the heat exchange element used fulfils certain criteria for it to function in the process. For example, construction of the element is such that continuous self-cleaning of the heat exchange surfaces occurs. In order to avoid plugging of the heat exchanger and to maintain a high rate of heat transfer, the heat exchange element should have smooth and essentially vertical gas passages of relatively large dimension. As described above, a chamber portion or separation zone is provided at the base of the collector 110 to allow a separation between the condensate and the gas stream.

The gas stream 106 that is dirty (i.e. contains pollutant, typically including SOx if the fuel contains sulphur, or NH₃ if the fuel contains ammonia, or both SOx and NH3 if the fuel contains both sulphur and ammonia) and that has been humidified and that has gaseous reagent (i.e. NH₃ if the fuel contains sulphur, or SOx if the fuel contains ammonia, or NH₃ and/or SOx if the fuel contains both sulphur and ammonia) is introduced into the upstream end of the collector by way of the pipe 108 between the inlet 102 and the collector. This is then distributed uniformly among the heat exchanger tubes 116, in some examples, by a tapered housing (not shown). A tapered housing would direct the gas stream toward the entrance to the tubes 116 of the heat exchanger 112, also referred to as a “tube sheet”. Alternative arrangements are also possible, each of which generally distribute the gas stream over the tube sheet. Gas passes upwardly through the heat exchange tubes, at step 206, which progressively condense out water vapour contained in the gas while simultaneously trapping and removing particles contained in the gas.

Disposed below the heat exchange tubes 116 is the chamber portion used to collect the condensate. Condensate flows (either in a stream or in drips) from the upstream end of the tubes collects in the chamber at step 208. A gas stream 106, now substantially cleaned of its entrained particles, is released into the atmosphere at step 210 through an outlet 104.

The gas stream 106 entering the heat exchanger 112 should contain enough water vapour so that its saturation point, provided by its water dew point, is sufficiently above the temperature of the heat exchange elements to provide condensation of water. In this example, this means that the water dew point of the incoming gas is at a temperature of at least 2° C., and such as at least 5° C., above the temperature maintained in the heat exchanger. In some examples, the water dew point of the gas entering the heat exchanger is least 50° C. and may be more than 65° C.

Additionally, as noted above, the temperature of the exhaust gas is typically above 200° C. In order for the heat exchanger 112 to be most effective, the temperature of the exhaust gas should be less than 200° C., for example, be about 150° C. at an inlet to the tubes 116 of the heat exchanger. This is due to the heat exchanger operating to drop the exhaust gas temperature from about 150° C. to, for example, about 60° C. or less. Water provided to the gas stream 106 to include water vapour in the gas also acts to lower the temperature of the gas stream. As well as allowing the gas to reach an optimal humidity content, the water provided is therefore also used to allow the initial gas temperature to drop from about 230° C. to about 150° C. The quantity of water provided affects the reduction in temperature achievable. This cooling effect is thus also factored into a calculation as to how much water to provide into the gas stream at one or more of the feeds upstream of the heat exchanger. This calculation is of course also conducted factoring in a quantity of water to be injected based on the gas mass flow to provide a suitable quantity of water to capture pollutants, for reactions to occur at a suitable rate and to allow the gas to reach an optimal humidity content at the intended temperature.

The diameter of the heat exchange tubes 116 should be sufficient so as to preclude a possibility of plugging by build-up of particles on their inner surfaces.

The minimum workable interior diameter of the heat exchange tubes depends on a number of process variables. These include particulate loading of the gas stream, amount of water vapour condensed from the gas stream, tube length, and gas velocity within the tube. In some examples, the tube diameter is within the range of about 2 centimetres (cm) to about 10 cm and the length is typically in a range from 1 metres (m) to 10 m. This is appropriate for most industrial gas streams.

As set out above, the geometry of the heat exchanger 112 includes a number of tubes 116. An internal tube diameter and length of the tubes to be used for the heat exchanger is able to be calculated based on the residence time of gas in the tubes for the reaction to occur. In various examples, this can be between 0.01 seconds(s) and 10 s. The typical residence time is around 0.3 s, which is consistence with the range of tube lengths set out above.

As shown in FIGS. 1 and 2, various examples, at step 212, optionally include an additional water feed loop from the chamber portion into the collector 110 at the gas stream inlet into the collector (and therefore at the point the pipe 108 connects to the collector). In such examples, the concentration of the condensate can be decreased as the condensation rate will increase due to the increased humidity this will provide the gas stream 106 without adding further pollutant. This is provided by the third feed 132.

In some examples, optionally, an additional water feed is introduced into the collector 110 downstream (and therefore above) the heat exchanger 112, at step 214. This enhances cleaning and flushing of the heat exchange surfaces. In several of such examples, the flushing is accomplished by providing an inflow centrally located above the heat exchange element. The auxiliary water inflow can either be operated continuously or can be operated on an intermittent basis to flush the heat exchange surfaces. In the collector, in these examples, the source of the water into the inflow is from the chamber portion collecting the condensate, and therefor is provided by the fourth feed 138. By providing this second recirculation loop, the concentration of the condensate is able to be increased through water evaporation and contributing to the particle material removal from the exhaust gas.

In addition to the described effects of both recirculation loops, injecting additional water to the exhaust gas contributes to control the dew point of the exhaust gas. As described, this is a key parameter for the particle material removal. This parameter is function of the partial pressure of the water in the gas mixture and condensation happens when this partial pressure is below the saturation pressure of the water. The condensation rate is proportional to the difference between the partial pressure of water and the saturation pressure of water at the corresponding temperature. The various feeds are, however, not the only contributors to the regulation of condensation or change in partial pressure of the water in the gas stream 106. This is because, in addition to the feeds, the surface of the condensate 130 within the base of the collector 110 receives directly heat from the gas stream. As a result, following the second law of thermodynamics, the heat from the gas stream is transferred to the condensate at the base of the collector due to the temperature difference between the gas stream at a higher temperature and the condensate at a lower temperature. As a consequence, the condensate will partially evaporate, increasing the water content of the gas stream at an entrance to the heat exchanger. Thus, this increases the temperature of the dew point, which is advantageous for the process described herein.

In some examples, the water injection provided at step 204 is provided only by injection of condensate by the third feed 132. In such examples, water injection is not provided by the first or second feeds 122, 126. The quantity of water provided by any feed, and reagent provided by the first or second feed is controlled based on the conditions of the gas 106, the concentration of ammonium sulphate in the condensate being sought and the environmental conditions affecting the conditions in which the process is carried out and that the apparatus is experiencing.

The recirculation processes provided by the third feed 132 and fourth feed 138 are advantageous to maintain a saturated solution of ammonium sulphate in the collection chamber. To be able to efficiently transfer the condensate solution 130, it is advantageous to be in a completely liquid state, so that, for example, pumps can be used. It is also advantageous to keep the concentration of the ammonium sulphate solution at saturation, so that the storage capacity of the ammonium sulphate solution is optimised. This is advantageous when storage space is at a premium, for example, on board a ship. The ammonium sulphate solution can be used or processed for use as fertilizer.

The apparatus and process according to an aspect disclosed herein use water, and, as such, would typically be described as a wet scrubber and wet scrubbing process. However, it is possible for the process to be carried out without the addition of water from an external source. This is because, at least in some examples, the process is able to rely on the water used to cause the gas to reach its saturation point in the heat exchanger only coming from condensation formed within the apparatus (typically in the heat exchanger) and recirculation of the condensate. As such, it is also possible to consider the apparatus and process to be considers as a dry scrubber and dry scrubbing process.

1. An apparatus for removing pollutants from a gas, the apparatus comprising:
a gas flow path along which gas passes from an inlet to an outlet in use; and
a cooling device on the gas flow path and orientated so as to direct the gas flow path upward towards the outlet, wherein
the apparatus is arranged in use to provide water and gaseous reagent to gas upstream of the cooling device in quantities based on one or more properties of the gas and a cooling capability of the cooling device so as to cause the reagent to react with one or more constituents of the gas to produce a reaction product and to cause the gas to reach its saturation point when passing through the cooling device thereby causing water in the gas to capture the reaction product, condense and pass out of the gas.

2. The apparatus according to claim 1, further comprising a reagent feed upstream of the cooling device, the apparatus being arranged in use to provide reagent to the gas by the reagent feed being arranged in use to pass reagent into the gas.

3. The apparatus according to claim 1, wherein the one or more constituents of the gas are pollutants and the quantity of reagent provided to the gas is based on the concentration of the pollutants in the gas.

4. The apparatus according to claim 3, further comprising a pollutant monitor arranged in use to detect pollutants in the gas downstream of the cooling device.

5. The apparatus according to claim 3, wherein the reagent comprises gaseous ammonia (NH₃, NH3) and the pollutant comprises sulphur oxides (SOx), the ammonia being arranged in use to react with the sulphur oxides in the gas; and wherein the reagent comprises gaseous sulphur oxides (SOx) and the pollutant comprises ammonia (NH3, NH3), the sulphur oxides being arranged in use to react with the ammonia in the gas.

6. (canceled)

7. The apparatus according to claim 1, further comprising a water feed upstream of the cooling device, the apparatus being arranged in use to provide water to the gas by the water feed being arranged in use to pass water into the gas.

8. The apparatus according to claim 7, wherein the quantity of water provided to the gas is based on a temperature in the cooling device and the temperature of the gas upstream of the water feed.

9. The apparatus according to claim 1, further comprising a collector positioned to catch condensed solution of water and captured reaction product passing out of the cooling device.

10. The apparatus according to claim 9, wherein the apparatus is arranged in use to provide condensed solution from the collector to the gas upstream of the cooling device as at least a portion of the water to be provided to the gas; and wherein the apparatus is arranged in use to provide condensed solution from the collector into the gas flow path downstream of the cooling device.

11. (canceled)

12. The apparatus according to claim 9, wherein the gas flow path passes to a surface of the condensed solution caught at the collector, the heat from the gas passing along the gas flow path thereby passing to the condensed solution.

13. The apparatus according to claim 9, wherein the apparatus is arranged in use to monitor the concentration of reaction product in the condensed solution in the collector, the apparatus being further arranged in use, based on the monitored concentration, to adjust water content of the gas at the cooling device.

14. The apparatus according to claim 13, wherein the apparatus is arranged in use to provide condensed solution from the collector to the gas upstream of the cooling device as at least a portion of the water to be provided to the gas, and wherein the apparatus is arranged in use to decrease the concentration by providing condensed solution from the collector to the gas passing along the flow path to the cooling device.

15. The apparatus according to claim 13, wherein the apparatus is arranged in use to provide condensed solution from the collector into the gas flow path downstream of the cooling device, and wherein the apparatus is arranged in use to increase the concentration by providing condensed solution from the collector into the gas flow path downstream of the cooling device.

16. The apparatus according to claim 13, wherein the concentration of reaction product in the captured condensed solution is maintained between about 30% weight and about 60% weight.

17. The apparatus according to claim 1, wherein the cooling device is a heat exchanger.

18. (canceled)

19. (canceled)

20. (canceled)

21. The apparatus according to claim 1, wherein water provided to the gas provides a water content in the gas of between about 5% by volume and 15% by volume.

22. A method of removing pollutants from a gas, the method comprising:
providing water and gaseous reagent to a gas; and
passing the gas through a cooling device to cool the gas, wherein the water and reagent are provided to the gas in quantities based on one or more properties of the gas and a cooling capability of the cooling device so as to cause the reagent to react with one or more constituents of the gas to produce a reaction product and to cause the gas to reach its saturation point when passing through the cooling device thereby causing water in the gas to capture the reaction product, condense and pass out of the gas.

23. The method according to claim 22, wherein the gas is a waste gas or exhaust gas.

24. The method according to claim 22, further comprising monitoring one or more properties of the gas before providing water and reagent and, based on one or more monitored properties, adjusting the quantity of water and/or reagent provided to the gas.

25. The method according to claim 22, further comprising collecting condensed solution of water and reaction product and monitoring the concentration of reaction product in the condensed solution; and
adjusting, based on the monitored concentration, the concentration by providing condensed solution to the gas upstream of the cooling device or to a downstream end of the cooling device.
